(19) United States
(12) Patent Application Publication
(10) Pub. No.: US 2016/0368509 A1
(43) Pub. Date: Dec. 22, 2016

(54) METHOD FOR ADJUSTING A POSITION OF A COMPONENT OF A VEHICLE

(71) Applicant: FORD GLOBAL TECHNOLOGIES, LLC, Dearborn, MI (US)

(72) Inventor: Vaibhav UPPAL, Basildon (GB)

(21) Appl. No.: 15/183,005

(22) Filed: Jun. 15, 2016

(30) Foreign Application Priority Data
Jun. 17, 2015 (GB) 1510632.1

(51) Int. Cl. B60W 50/10; H04N 13/02; G06K 9/00

(52) U.S. Cl. CPC B60W 50/10; G06K 9/00845; G06K 9/00369; G06K 9/00255; H04N 13/0203; B60W 2540/00

(57) ABSTRACT

A method for determining a suitable position of an adjustable component of a vehicle is provided. A 3D image of an occupant of the vehicle is captured by a 3D camera. A controller receives images from the camera and determines a first morphological characteristic of the occupant based on the 3D image, determines a second morphological characteristic of the occupant by referring to data relating the first morphological characteristic to a prediction of the second morphological characteristic, generates a 3D representation of the occupant based on the first and second morphological characteristics, and determines the suitable position of the component of the vehicle according to the 3D representation.

### CROSS-REFERENCE TO RELATED APPLICATIONS

This application claims foreign priority benefits under 35 U.S.C. §119(a)-(d) to GB 1510632.1 filed Jun. 17, 2015, which is hereby incorporated by reference in its entirety.

### TECHNICAL FIELD

The present disclosure relates to a method for determining a suitable position for a component of a vehicle and is particularly, although not exclusively, concerned with a method of determining a suitable position for a component of a vehicle according to a determined morphological characteristic of an occupant.

### BACKGROUND

Adjusting the position(s) of components of a motor vehicle, such as a seat, a steering wheel or mirrors can be an important procedure before and during operation of the motor vehicle. Correctly adjusting the position of the seat and/or steering wheel may allow the driver to easily reach all driving controls and correctly adjusting the mirrors may provide suitable vision without the driver needing to depart from a comfortable driving position. On longer journeys, correct positional adjustment of ergonomic components may prevent injuries caused by poor driving posture.

When a motor vehicle is shared by several people, regularly adjusting the ergonomic components can be inconvenient and time consuming. This may result in drivers settling for uncomfortable driving positions which may provide inappropriate reach to driving controls and reduced vision, and may lead to poor driving posture.

### SUMMARY

According to an aspect of the present disclose, there is provided a method for determining a suitable position of a component of a vehicle. The method comprises: capturing a 3D image of an occupant of the vehicle; determining a morphological characteristic of the occupant based on the 3D image; and determining the suitable position of the component of the vehicle according to the determined morphological characteristic.

According to another aspect of the present disclosure, there is provided a method for adjusting an ergonomic component of a vehicle. The method comprises: capturing a 3D image of an occupant of the vehicle; determining a morphological characteristic of the occupant based on the 3D image; and adjusting the ergonomic component of the vehicle according to the determined morphological characteristic.

According to another aspect of the present disclosure, there is provided a method for determining a suitable position of a component of a vehicle with which the occupant interacts. The method comprises: capturing a 3D image of an occupant of the vehicle; determining a morphological characteristic of the occupant based on the 3D image; and determining the suitable position of the component of the vehicle according to the determined morphological characteristic.

The method may further comprise presenting the determined suitable position of the ergonomic component to the occupant. The method may further comprise adjusting the ergonomic component of the vehicle into the suitable position.

The component may comprise one or more of: a steering wheel, a seat, a head rest, a mirror or an information display.

The morphological characteristic may comprise a dimension of a body part of the occupant. The body part dimension may determine an ergonomic use of the component. The morphological characteristic may comprise one or more of: an arm length, a leg length, a torso length, a height, a seated height, a shoulder height, a posture, an eye level, a 3D representation of the occupant or any other characteristic of the vehicle occupant or driver.

The first morphological characteristic may be determined directly from the 3D image. Additionally or alternatively, a particular morphological characteristic may be determined at least partially by referring another morphological characteristic to a data model or look-up table, e.g. a table of anthropometric data.

The suitable position of the component may be calculated based on the determined morphological characteristic. Additionally or alternatively the suitable position of the component may be determined at least partially by referring to a data model or look-up table.

The method may further comprise processing the 3D image of the occupant, or a component image of the 3D image, to recognize a facial characteristic of the occupant. The morphological characteristic may comprise a recognized facial characteristic of the occupant.

The suitable position of the component may be determined by referring to a preset position associated with the morphological characteristic.

The method may further comprise associating the position of the ergonomic component with the morphological characteristic and storing the position with the associated morphological characteristic in a memory. The memory may be provided on a networked storage device or a central server, such as a cloud storage facility.

The morphological characteristic, with which the position of the ergonomic component is associated, may be a facial characteristic of the occupant.

The method may further comprise adjusting the component of the vehicle following a change to the morphological characteristic.

The component may comprise a mirror of the vehicle and the mirror may be adjusted such that a field-or-view provided to the occupant by the mirror is substantially unaffected by the change to the morphological characteristic.

According to another aspect of the present disclosure, there is provided a method for storing a position of a component of a vehicle. The method comprises: capturing a 3D image of an occupant of the vehicle; determining a morphological characteristic of the occupant based on the 3D image; associating the position of the ergonomic component with the morphological characteristic; and storing the position and associated morphological characteristic in a memory.

The memory may be provided on a networked storage device or a central server, such as a cloud storage facility.

The method may further comprise: processing the 3D image of the occupant, or a component image of the 3D image, to recognize a facial characteristic of the occupant. The morphological characteristic may comprise a recognized facial characteristic of the occupant.

According to another aspect of the present disclosure, there is provided a controller comprising one or more modules configured to perform the method according to a previously mentioned aspect of the disclosure.

The controller may comprise a memory configured to store positions and/or orientations of ergonomic components of the vehicle together with associated morphological characteristics.

According to another aspect of the present disclosure there is provided software, which when executed by a computing device causes the computing device to perform the method according to a previously mentioned aspect of the disclosure.

According to another aspect of the present disclosure, there is provided a vehicle comprising an ergonomic component, a 3D camera and the controller according to a previously mentioned aspect of the disclosure.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

For a better understanding of the present invention, and to show more clearly how it may be carried into effect, reference will now be made, by way of example, to the accompanying drawings, in which:

### BRIEF DESCRIPTION OF THE DRAWINGS

FIG. 1 is a sectional view of a previously proposed motor vehicle comprising adjustable ergonomic components;

FIG. 2 is a top view of a previously proposed motor vehicle comprising adjustable ergonomic components;

FIG. 3 is a sectional view of a motor vehicle comprising adjustable ergonomic components, according to an arrangement of the present disclosure;

FIG. 4 shows a method for adjusting an ergonomic component of a motor vehicle according to an arrangement of the present disclosure;

FIG. 5 shows a method for setting a position of an ergonomic component of a motor vehicle according to an arrangement of the present disclosure;

FIG. 6 is a schematic view of a controller configured to adjust an ergonomic component of a motor vehicle according to an arrangement of the present disclosure; and

FIG. 7 is a schematic view of a controller configured to store a position of an ergonomic component of a motor vehicle according to an arrangement of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

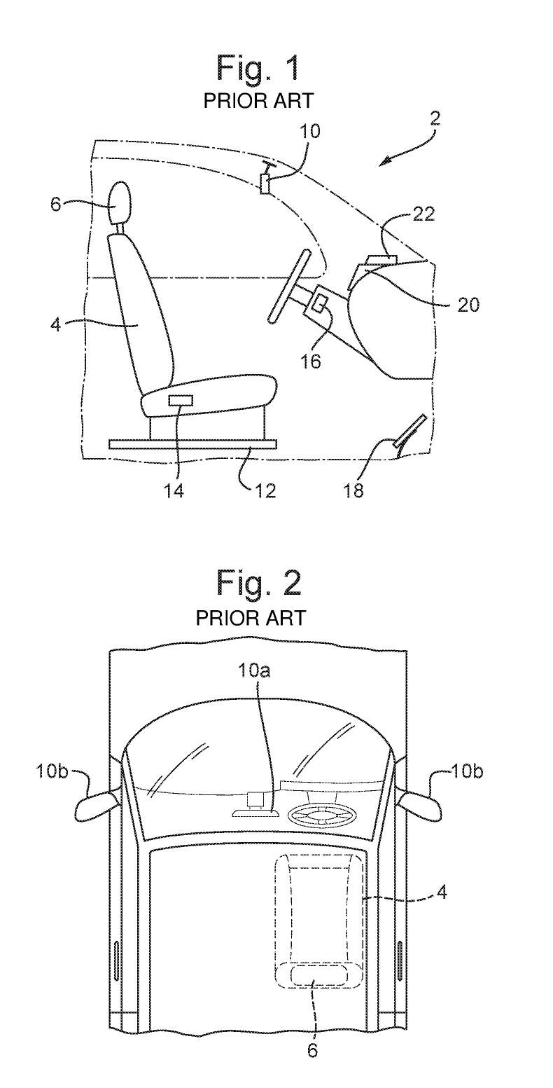

With reference to FIG. 1, a vehicle, such as a motor vehicle 2, may comprise a plurality of components with which an occupant of the vehicle interacts, such as a seat 4, a head rest 6, a steering wheel 8 and mirrors 10.

The position of the seat 4 may be adjustable. For example, the seat may be provided on rails 12, which may permit the seat to be adjusted forwards and backwards within the vehicle as desired to achieve a comfortable driving position, e.g. such that pedals 18 can be easily reached. The seat 4 may also be adjustable in a vertical direction. Additionally or alternatively, the angle of recline of the seat 4 may be adjustable. The seat may be adjustable in any other direction or about any other axis.

The seat 4 may comprise the head rest 6, which may be adjustable in the vertical direction relative to the seat 4, to provide support for the head of the occupant. Additionally or alternatively, the seat may comprise other adjustable elements or surfaces.

Adjustment of the seat 4 and/or head rest 6 may be performed manually, for example through the use of a manually actuated ratchet mechanism or a screw mechanism (not shown). Alternatively, the vehicle 2 may be provided with a powered adjustment means (not shown), such as an electric motor or a pneumatic or hydraulic actuation system, which may be controllable to adjust the seat 4 and/or head rest 6 as desired. A plurality of powered adjustment means may be provided, which may be individually controllable to move the seat 4 and/or head rest 6 in each available direction of adjustment.

A seat control means 14 may be provided, which allows an occupant of the seat to control each of the powered adjustment means to adjust the seat 4 and/or head rest 6. The seat control means 14 may comprise a series of buttons and/or switches. Additionally or alternatively, the seat control means 14 may comprise a multi-directional control lever, allowing simultaneous adjustment in each of the adjustment directions.

The position of the steering wheel 8 may be adjustable to enable the occupant of the seat to comfortably reach the steering wheel and any driving controls provided thereon. The position of the steering wheel 8 may be adjustable in the forwards and rearwards direction and/or the vertical direction. The steering wheel 8 may be manually adjustable in a similar way to that described above with reference to the seat 4 and head rest 6. Alternatively, additional powered adjustment means may be provided which are controllable, e.g. by the occupant, to adjust the position of the steering wheel. A steering wheel control means 16 may be provided to allow the position of the steering wheel to be adjusted using the additional powered adjustment means.

With reference to FIG. 2, the mirrors 10 of the vehicle comprise a rear-view mirror 10a and wing mirrors 10b. The rear-view mirror 10a may be provided substantially centrally within the vehicle and may be configured to provide the driver with a view in a substantially central area behind the driver. The wing mirrors 10b may be provided on the left and right sides of the vehicle and may be configured to provide the driver with a view behind the driver to the left and right sides of the vehicle respectively.

The position of the mirrors may be adjusted by the driver to provide desired visibility during driving. In particular, the mirrors may be adjusted such that vehicles in proximity to the vehicle, either travelling directly behind the vehicle or in an adjacent lane, can be seen by the driver. Additionally or alternatively, mirrors may be used by the driver during certain maneuvers, e.g. reversing, to provide vision of any obstacles around the vehicle.

The driver may adjust the rear view mirror such that the least amount of the driver's view in the rear view mirror is obscured by any portion of the vehicle, which is behind the driver. The driver may adjust the wing mirrors such that a rear portion of the vehicle is visible in the mirror in order that the driver may judge the distance to other vehicles and objects visible in the mirror.

The view provided to the driver by the mirrors 10 may be dependent on the position of the driver within the vehicle and hence the driver may adjust the mirrors 10 once other components, such as the seat 4, head rest 6 and steering wheel 8 have been adjusted to provide a comfortable driving position.

Similar to the seat, headrest and steering wheel, the mirrors may be manually adjustable or comprise further powered adjustment means (not shown), which allow the driver to adjust the position of the mirrors 10 using a further control means (not shown)

With reference to FIG. 1, the vehicle 2 may further comprise an information display, such as an instrument panel 20 and/or a heads-up display 22, which provides information to the driver such as current speed, engine RPM, navigation instructions or any other data. The position of the display may be adjustable, in a similar way to the other components described above, to provide the best view to the driver.

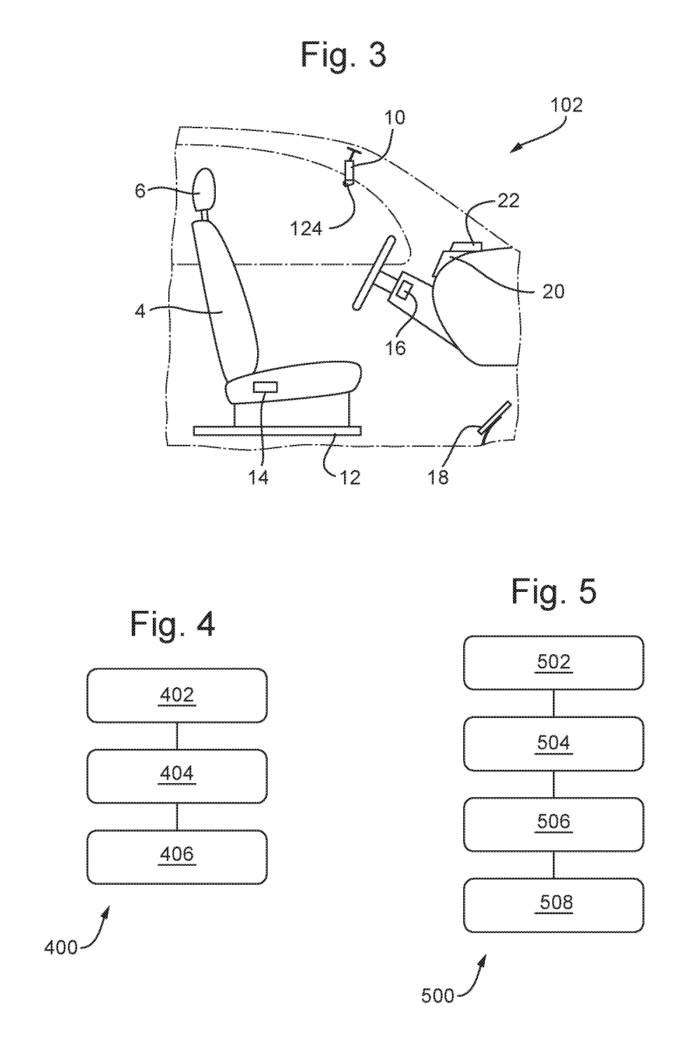

With reference now to FIG. 3, a vehicle 102 according to an arrangement of the present disclosure comprises the components 4, 6, 8, 10, 20, 22 with which the occupant of the vehicle interacts, as described above. The vehicle 102 may further comprise a camera, such as a 3D Camera 124. The 3D camera 124 may be provided within the vehicle 102 and may be configured to capture a 3D image of an occupant, e.g. a driver, of the vehicle. The 3D Camera 124 may be provided on or as part of the rear view mirror 10a. Additionally or alternatively, the 3D camera 124 may be provided on a dashboard of the vehicle, for example, the 3D camera may be provided on or as part of the instrument panel 20. Again additionally or alternatively, the 3D camera 124 may be provided on or within a panel of the vehicle such as a ceiling panel, or in any other location on the vehicle where the 3D camera may be configured to capture an image of at least part of the vehicle occupant.

The 3D camera 124 may comprise two or more cameras, such as digital cameras, which may be arranged in offset positions relative to one another. In other words, the cameras may be spaced apart from one another. The cameras may have an overlapping field-or-view. Using data from the two cameras, 3D information can be extracted by combining the relative positions of objects or parts of objects in the two images. Alternatively, one of the cameras may comprise a depth sensor, e.g. an infrared laser projector and sensor. The 3D camera may further comprise a controller configured to convert images captured by the cameras into the 3D image. Alternatively, the 3D camera may comprise any other system capable of producing a 3D image. The 3D image may comprise information relating to a distance from an object captured in the image to the 3D camera. The 3D image may allow a 3D position of the object, relative to the camera, to be determined and/or a 3D representation of the object to be generated.

The 3D image captured by the 3D camera may allow a morphological characteristic of the occupant to be determined. The morphologic characteristic may be a dimension of a body part of the occupant, such as an arm length or leg length. The morphological characteristic may comprise, but is not limited to, the height, eye level, arm length, leg length, torso length, height, seated height, shoulder height or posture of the occupant. The morphologic characteristic of the occupant may be determined, e.g. directly determined, from the 3D image. Additionally or alternatively, the 3D image may be used to generate a 3D representation of the occupant. The 3D representation may comprise multiple morphological characteristics of the occupant. The 3D representation may comprise morphological characteristics which can be directly determined from the 3D image.

Additionally or alternatively, the 3D representation may comprise additional morphological characteristics of the occupant that may not be determined directly from the 3D image. For example the full length of the occupant's legs may not be visible to the 3D camera 124 and hence may not be determined directly from the 3D image. In this case the additional morphological characteristic may be predicted. A data model or look-up table may be provided which relates certain morphological characteristics of a person to other morphological characteristics. For example, the seated height, torso length, arm length and/or head position of the occupant may be used to calculate or look up an expected leg length of the occupant. A plurality of the measured morphological characteristics of the occupant may be provided as inputs to the data model to predict additional morphological characteristics. The data model may comprise one or more sets of anthropometric data.

With reference to FIG. 4, a method 400 for determining a suitable position of a component of a vehicle, according to an arrangement of the present disclosure, comprises a first step 402, in which at least a partial 3D image of an occupant of the vehicle is captured, a second step 404, in which a morphological characteristic of the occupant is determined, based on the 3D image, and a third step 406, in which a suitable position of the component of the vehicle is determined according to the morphological characteristic.

In the third step 406, the 3D representation of the occupant and/or one or more other morphological characteristics of the occupant may be used to determine a suitable position of one or more of the components of the vehicle 102, e.g. to provide a comfortable driving position for the driver. For example, the leg length of the driver may be used to determine a suitable fore/aft seat position; the height and/or eye level of the driver may be used to determine a suitable seat height and/or seat recline angle; the driver arm length and/or shoulder height may be used to determine a suitable steering wheel position. The suitable positions may be determined to provide an optimal ergonomic position for the driver. For example, the ergonomic position may help to prevent fatigue or injuries caused by poor driving posture on long journeys.

The 3D representation of the occupant and/or one or more morphological characteristics of the occupant, such as the eye position of the occupant, may be used to determine suitable positions and/or orientations of the mirrors 10, in order to provide the driver with suitable vision. The suitable positions and/or orientations of the mirrors 10 may be dependent on the positions and/or orientations of the other ergonomic components, hence the suitable positions and/or orientations of the mirrors 10 may be determined subsequently to the other ergonomic components.

The suitable positions and/or orientations of the components may be determined by performing a calculation based on one or more of the morphological characteristics. Additionally or alternatively, the suitable positions and/or orientations of the components may be determined by referring to a data model or look-up table. The suitable positions and/or orientations may be determined by assuming that other components will also be adjusted into suitable positions.

The suitable positions and/or orientations, which are determined by the method 400 may be presented to the occupant, for example on the instrument panel 20 or using the heads up display 22, so that the occupant may optionally adjust the positions and/or orientations of the components. Accordingly, the method 400 may further comprise a fourth step, in which the suitable positions and/or orientations are presented to the occupant. Additionally or alternatively, the vehicle may automatically adjust the components, e.g. using the powered adjustment means described above, into the determined suitable positions and/or orientations. Accordingly, the method 400 comprises a fifth step, in which the components are automatically adjusted into the suitable positions and/or orientations.

The fourth step and/or fifth step may be performed subsequently to the other steps of the method 400. Alternatively the fourth step and/or fifth step may be performed concurrently with the other steps of the method 400, e.g. a suitable position for one component may be presented and/or adjustment of the component may be performed whilst suitable positions and/or orientations for other components are still being determined.

The occupant may adjust each of the components manually and/or by using a control panel, such as control means 14, 16, provided for the purpose. Adjustments may be made by the occupant to adjust the components into the suitable positions, which have been presented to the user. Alternatively the components may be adjusted into alternative positions, which the occupant find more comfortable. Such adjustment may be performed before and/or after automatic adjustment has been performed. Alternatively, the occupant may adjust the components manually and/or by using a control panel without first using the method 400 to determine suitable positions and/or orientations. In other words, the automatic adjustment may be overridden.

With reference to FIG. 5, a method 500 for storing a position of a component of a vehicle, according to an arrangement of the present disclosure, comprises a first step 502 in which a 3D image of an occupant of the vehicle is captured; a second step 504, in which a morphological characteristic of the occupant is determined based on the 3D image; a third step 506, in which the position of the component is associated with the morphological characteristic; and a fourth step 508, in which the position and associated morphological characteristic are stored in a memory.

Once the components have been adjusted, automatically and/or by the occupant, e.g. manually and/or by using a control panel, the adjusted positions and/or orientations may be stored in a memory, e.g. a computer memory such as random access memory or a non-volatile memory such as a hard disc drive. The memory may be provided on the vehicle or on a central server, such as a cloud storage facility. The adjusted positions may be associated with one or more determined morphological characteristics of the occupant, which may also be stored in the memory. The memory and/or the storage facility may have the capacity to store the adjusted positions and associated morphological characteristics of many occupants who use the vehicle, e.g. all occupants who use the vehicle during the lifetime of the vehicle. The occupants of the vehicle may therefore be remembered by a system or controller of the vehicle, as described below, together with the adjusted positions of the components.

If a future occupant is subsequently detected, who has one or more morphological characteristics that are substantially the same as one or more of those stored in the memory, the stored, e.g. preset, positions and/or orientations of the components may be recalled, and may be presented to the occupant and/or used to adjust the components, instead of determining suitable positions and/or orientations using the method 400, as described above.

Additionally, if the occupant enters a second vehicle, which also has access to the memory, e.g. within the cloud storage facility, one or more morphological characteristics of the occupant may be recognized as those stored within the memory, the positions and/or orientations of the components stored in the memory may be recalled, and the recalled positions and/or orientations may be presented to the occupant and/or used to adjust the components in the second vehicle.

The occupant may selectively determine whether morphological characteristics and associated positions and/or orientations of the components are stored in the cloud facility and/or whether they may be accessed by other vehicles as described above. The occupant may also determine which specific vehicles are able to access the morphological characteristics and associated positions and/or orientations which have been stored.

Whether memory is local to the vehicle, or provided on a central server, when the adjusted positions and/or orientations are stored in the memory, the seat of the vehicle, e.g. a driver's seat or a passenger seat, in which the occupant is sitting, may also be stored in the memory. The stored positions and/or orientations of the components may only be recalled when an occupant having one or more of substantially the same morphological characteristics is detected in the same seat. This may allow a user to have different stored seating preferences when sat in different seats of the vehicle. Additionally or alternatively, positions of components, which relate to driver controls and visibility, e.g. steering wheel position, information display positions and/or mirror positions, may only be stored when the occupant is in the driver's seat. If the morphologic characteristics and associated components positions and/or orientations are stored on a central server assessable to a number of vehicle, the user may also store positions and/or orientations of components which are specific to a particular vehicle.

An image, e.g. a 3D image, captured by the camera may be processed to recognize a face of the occupant, for example by determining one or more facial characteristics of the occupant, such facial characteristics may include, but are not limited to, mouth shape, mouth position, nose shape, nose position, eye shape, eye color and/or pattern, e.g. of the iris of the eye, ear shape, ear position. The morphologic characteristic determined in the second step 404, 504 may comprise a recognized facial characteristic of the occupant. When the adjusted positions of the components are stored in the memory, as described above, the stored positions may be associated with the recognized facial characteristic, which may also be stored in the memory.

The recognized facial characteristic may be used to recall stored adjusted positions, which have been associated with the facial characteristic, as described above. Using a recognized facial characteristic may provide more accurate recognition of the occupant, which may allow the correct stored positions to be determined more accurately, compared to using other morphological characteristics for this purpose.

The method 400 may be performed when an occupant enters the vehicle. The 3D camera 124 may be configured to detect occupants entering the vehicle. Additionally or alternatively, a separate sensor, such as a weight sensor (not shown), may be used to determine when an occupant has taken the seat in the vehicle. The method 400 may be performed at specific times and/or following specific events, for example when starting an engine of the vehicle. A control means (not shown) may be provided to allow the occupant to prevent the method 400 and/or the method 500 from being performed. Additionally or alternatively, the control means may allow the occupant to selectively command the method 400 and/or the method 500 to be performed.

The method 400 may be repeated periodically during operation of the vehicle. Additionally or alternatively, the method 400 may be repeated when a change is detected to one or more morphologic characteristics, for example, eye level or posture of the occupant. When the method 400 is repeated, the suitable positions of the ergonomic components may be presented to the occupant and/or the ergonomic components may be automatically adjusted. For example, the mirrors 10 may be automatically adjusted such that the field-or-view provided to the driver by the mirror is substantially unaffected by any change to a morphological characteristic, such as the eye-level or eye position of the driver. Certain components, for example the seat, may not be adjusted during repeat operations of the method 400, as it may be determined that these are not suitable for adjusting during certain periods of operation of the vehicle, for example whilst driving.

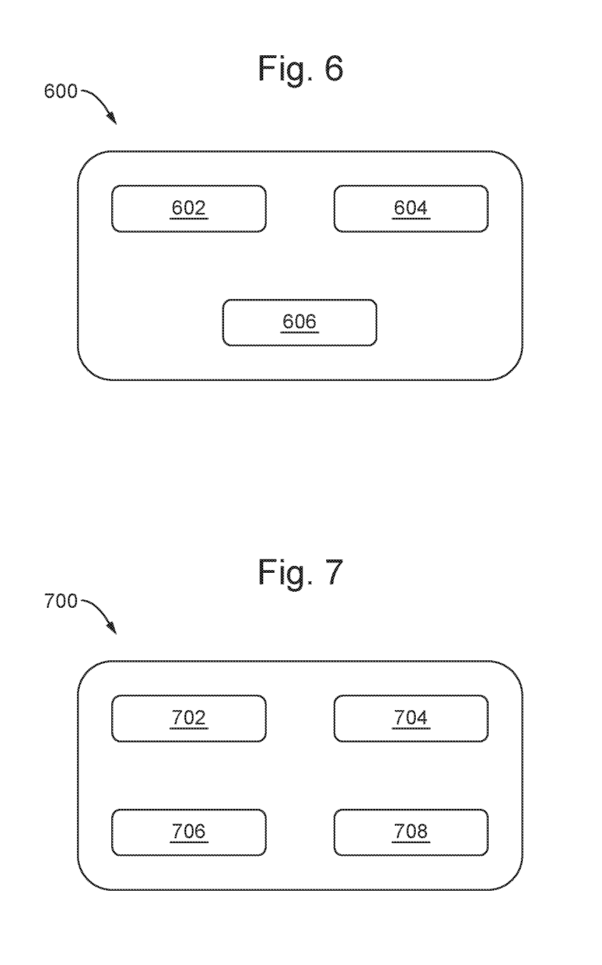

With reference to FIG. 6, a controller 600 for determining a suitable position of a component of a vehicle, according to an arrangement of the present disclosure, may comprise a first module 602, configured to capture a 3D image of an occupant of the vehicle. The controller 600 may comprise a second module 604, configured to determine a morphological characteristic of the occupant, based on the 3D image. The controller 600 may comprise a third module 606, configured to determine the suitable position of the component of the vehicle according to the morphological characteristic.

With reference to FIG. 7, a controller 700 for storing a position of a component of a vehicle, according to an arrangement of the present disclosure, may comprise a first module 702 configured to capture a 3D image of an occupant of the vehicle; a second module 704 configured to determine a morphological characteristic of the occupant based on the 3D image; a third module 706 configured to associate the position of the component is with the morphological characteristic; and a fourth module 708, configured to store the position and associated morphological characteristic in a memory.

The controller 700 or a module 702, 704, 706, 708 of the controller may further comprise the memory for storing the positions and/or orientations and the associated morphological characteristics of occupants.

The controller 700 may comprise one or more modules configured similarly to the modules 602, 604, 606 provided within the controller 600, or vice versa.

It will be appreciated by those skilled in the art that although the invention has been described by way of example with reference to one or more examples, it is not limited to the disclosed examples and alternative examples may be constructed without departing from the scope of the invention as defined by the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for adjusting a position of a component of a vehicle, comprising:
capturing a 3D image of a vehicle occupant using a vehicle-mounted camera;
determining a first morphological characteristic of the occupant based on the 3D image;
determining a second morphological characteristic of the occupant by referring to data relating the first morphological characteristic to a prediction of the second morphological characteristic;
generating a 3D representation of the occupant based on the first and second morphological characteristics;
determining a suitable position of the component of the vehicle according to the 3D representation; and
automatically adjusting the component of the vehicle into the suitable position.

2. The method of claim 1, further comprising communicating the suitable position of the component to the occupant.

3. The method of claim 1, wherein at least one of the first and second morphological characteristics comprises a dimension of a body part of the occupant.

4. The method of claim 3, wherein at least one of the first and second morphological characteristics comprises at least one of an arm length, a leg length, a torso length, a height, a seated height, a shoulder height, a posture, and an eye level of the occupant.

5. The method of claim 1, wherein the data relating the first morphological characteristic to a prediction of the second morphological characteristic comprises at least one of a data model and a look-up table.

6. The method of claim 1, wherein the first morphological characteristic comprises a facial characteristic of the occupant, and the facial characteristic is recognized as matching data stored in a memory.

7. The method of claim 1, wherein determining the suitable position of the component comprises referring to a preset position associated with the morphological characteristic.

8. The method of claim 1, further comprising:
associating the suitable position of the component with the first morphological characteristic and storing the suitable position and the associated first morphological characteristic in a memory.

9. The method of claim 1, wherein the component comprises at least one of a steering wheel, a seat, a head rest, a mirror, and an information display.

10. The method of claim 1, wherein the component comprises a vehicle mirror, and the suitable position of the mirror is adjusted such that a field-of-view provided to the occupant by the mirror is substantially unaffected by a change to at least one of the first and second morphological characteristics.

11. A method comprising:
operating a controller to determine a first morphological characteristic of a vehicle occupant based on a 3D image obtained from a camera, and determine a second morphological characteristic of the occupant from data relating the first morphological characteristic to a prediction of the second morphological characteristic; and
moving a vehicle component to a position suitable for the occupant based upon a 3D representation generated from the first and second morphological characteristics.

12. The method of claim 11, further comprising communicating the suitable position of the component to the occupant.

13. The method of claim 11, wherein at least one of the first and second morphological characteristics comprises a dimension of a body part of the occupant.

14. The method of claim 13, wherein at least one of the first and second morphological characteristics comprises at least one of an arm length, a leg length, a torso length, a height, a seated height, a shoulder height, a posture, and an eye level of the occupant.

15. The method of claim 11, wherein the data relating the first morphological characteristic to a prediction of the second morphological characteristic comprises at least one of a data model and a look-up table.

16. The method of claim 11, wherein the first morphological characteristic comprises a facial characteristic of the occupant, and the facial characteristic is recognized as matching data stored in a memory.

17. The method of claim 11, wherein determining the suitable position of the component comprises referring to a preset position associated with the morphological characteristic.

18. The method of claim 11, further comprising:
associating the suitable position of the component with the first morphological characteristic and storing the suitable position and the associated first morphological characteristic in a memory.

19. The method of claim 11, wherein the component comprises at least one of a steering wheel, a seat, a head rest, a mirror, and an information display.

20. A method for adjusting a position of a component of a vehicle, comprising:
operating a vehicle mounted camera to capture a 3D image of a vehicle occupant;
operating a controller to: a) determine a first morphological characteristic of the occupant based on the 3D image; b) determine a second morphological characteristic of the occupant by referring to stored data relating the first morphological characteristic to a prediction of the second morphological characteristic; c) generate a 3D representation of the occupant based on the first and second morphological characteristics; and d) determine a suitable position of the component of the vehicle according to the 3D representation; and
activating a motor to adjusting the component of the vehicle into the suitable position.
